(19) United States
(12) Patent Application Publication
(10) Pub. No.: US 2025/0007554 A1
(43) Pub. Date: Jan. 2, 2025

(54) METHOD FOR CONFIGURING AN OPERATING MODE FOR A PLURALITY OF TRANSCEIVERS, A COMPUTER PROGRAM PRODUCT, AN APPARATUS, AND A DIGITAL INTERFACE THEREFOR

(71) Applicant: BEAMMWAVE AB, Lund (SE)

(72) Inventors: Bengt Lindoff, Bjärred (SE); Markus Törmänen, Södra Sandby (SE); Per-Olof Brandt, Lomma (SE); Joakim Axmon, Limhamn (SE)

(21) Appl. No.: 18/709,021

(22) PCT Filed: Nov. 15, 2022
(86) PCT No.: PCT/SE2022/051067

§ 371 Date: May 9, 2024

(30) Foreign Application Priority Data
Nov. 22, 2021 (SE) 2130319-3

(51) Int. Cl. H04B 1/401; H04B 7/08; H04B 17/318

(52) U.S. Cl. CPC H04B 1/401; H04B 7/0874; H04B 17/318

(57) ABSTRACT

A method for a processor, the processor being connectable to a plurality of transceivers via one or more digital interfaces, comprising: configuring a first set of the plurality of transceivers to be in a first operating mode for a first time period; configuring a second set of the plurality of transceivers to be in a non-operating mode for the first time period; configuring the second set of transceivers to be in a second operating mode for a second time period, the second time period following the first time period; during the second time period obtaining a signal quality/strength for each of the plurality of transceivers; and at the end of the second time period, updating the first and second sets of transceivers based on the obtained signal quality/strength. Corresponding computer program product, apparatus and digital interface are also disclosed.

### TECHNICAL FIELD

The present disclosure relates to a method for a processing unit to configure a plurality of transceivers to be in a first operating, a second operating or a non-operating mode, a computer program product, an apparatus, and a digital interface therefor. More specifically, the disclosure relates to a method for a processing unit to configure a plurality of transceivers to be in a first operating, a second operating or a non-operating mode, a computer program product, an apparatus, and a digital interface as defined in the introductory parts of the independent claims.

### BACKGROUND ART

Typical architectures for transceivers supporting cellular communication (such as 3G, 4G, 5G, 6G) comprises a radio part, comprising one or more RF chips, with the aim of down converting and analog to digital (AD) converting the radio signal to a digital baseband signal on the receiver side, and upconverting and digital to analog (DA) converting a digital baseband signal to a radio signal on the transmitter side, and a baseband (BB) processor processing, targeting baseband procedures, such as channel estimation, decoding on the receiver side, and encoding on the transmitter side as well as performing data bit protocol handling on both the transmitter and receiver side.

The interface between the radio and BB processor parts is typical digital and, in many implementations, transporting the digital baseband signal in a serial fashion over the interface. Hence the digital baseband signals from the I and Q branches are multiplexed to a serial bit stream transported over the digital interface. Therefore, the bit stream frequency over the digital interface is much higher than the sampling rate of the digital baseband signal. One of the main reasons for serializing the bit stream is to limit the number of I/O pins of an integrated circuit (IC) chip needed for the bit transfer, since I/O pins are a constrained resource on IC chips.

Due to the high clock frequency for the digital interface, the power consumption of the digital interface, and parts thereof, such as a serializer/deserializer (SerDes), is typically high, as an average and/or momentarily. This is especially true for millimetre Wave (mmW) communication, i.e. communication utilizing the 24-300 GHz frequency range, using digital beamforming receivers aiming at Gigabit/second (Gbit/s) rates over the air interface, where many antennas distributed over a user equipment (UE) may be needed to combat the path loss and blocking problems present at mmW radio frequencies and requiring signal bandwidth up to 100 MHz and more, having ADC/DAC sample rates of 250-1000 MHz, giving digital I/F rates of 10-100 Gbits/s depending on bit resolution and exact RF architecture needed.

Hence there may be a need for reduction of the power consumption and/or of power spikes for the bit transfer in a digital interface between RF chips and a BB processor.

A digital transceiver circuit is known from WO2017/161347 A1. The digital transceiver circuit is connected to an antenna element via amplifiers on one end and to a baseband processing circuit on another end. The digital transceiver circuit includes an analog-to-digital converter (ADC), a digital-to-analog converter (DAC), a phase-locked loop (PLL), a digital downconverter (Dig Dn Converter), a digital upconverter (Dig Up Converter), and serializer/deserializer (SerDes). However, the only power saving suggestion given in this document is to perform processing in the digital domain.

### SUMMARY

An object of the present disclosure is to mitigate, alleviate or eliminate one or more of the above-identified deficiencies and disadvantages in the prior art and solve at least the above-mentioned problem.

According to a first aspect there is provided a method for a processing unit. The processing unit is connectable to a plurality of transceivers via one or more digital interfaces. The method comprises configuring a first set of the plurality of transceivers to be in a first operating mode for a first time period; configuring a second set of the plurality of transceivers to be in a non-operating mode for the first time period; configuring the second set of transceivers to be in a second operating mode for a second time period, the second time period following the first time period; during the second time period obtaining a signal quality/strength for each of the plurality of transceivers; and at the end of the second time period, updating the first and second sets of transceivers based on the obtained signal quality/strength. By utilizing a first operating, a second operating and a non-operating mode for the plurality of transceivers, power consumption and/or power spikes may be reduced.

According to some embodiments, the method comprises repeating the steps mentioned for the first aspect.

According to some embodiments, for each of the transceivers in the first operating mode, a first number of bits describing a signal is transmitted to/from the processing unit via an associated digital interface, and for each of the transceivers in the second operating mode, a second number of bits describing a signal, the second number of bits being lower than the first number of bits, is transmitted to the processing unit via an associated digital interface and for the transceivers in the non-operating mode, zero bits describing a signal are transmitted to the processing unit.

According to some embodiments, the method comprises receiving synchronization signals during the second time period.

According to some embodiments, receiving synchronization signals comprises receiving synchronization signals for each of the plurality of transceivers simultaneously.

According to some embodiments, obtaining the signal quality/strength for each of the plurality of transceivers is based on the simultaneously received synchronization signals.

According to some embodiments, obtaining the signal quality/strength for each of the plurality of transceivers comprises obtaining the signal quality/strength for each of the plurality of transceivers from a corresponding synchronization signal.

According to some embodiments, receiving synchronization signals comprises receiving the same synchronization signal for each of the plurality of transceivers.

According to some embodiments, the one or more synchronization signals are one or more synchronization signal blocks (SSBs).

According to some embodiments, configuring the second set of transceivers to be in a second operating mode for a second time period is only performed if the signal quality/strength for each of the transceivers of the first set of the plurality of transceivers fulfils a first criterion.

According to some embodiments, the signal quality is measured as a signal to noise ratio (SNR) and the first criterion is fulfilled if the SNR of one or more transceivers of the first set has a value above a first threshold.

According to some embodiments, the signal quality is measured as a signal to interference and noise ratio (SINR) and the first criterion is fulfilled if the SINR of one or more transceivers of the first set has a value above a first threshold.

According to a second aspect there is provided a computer program product comprising a non-transitory computer readable medium, having stored thereon a computer program comprising program instructions, the computer program being loadable into a data processing unit and configured to cause execution of the method of the first aspect or any of the above-mentioned embodiments when the computer program is run by the data processing unit.

According to a third aspect there is provided an apparatus, connectable to a plurality of transceivers via one or more digital interfaces, comprising control circuitry, the control circuitry being configured to cause: configuration of a first set of the plurality of transceivers to be in a first operating mode for a first time period; configuration of a second set of the plurality of transceivers to be in a non-operating mode for the first time period; configuration of the second set of transceivers to be in a second operating mode for a second time period, the second time period following the first time period; during the second time period, obtainment of a signal quality/strength for each of the plurality of transceivers; and at the end of the second time period, updating of the first and second sets of transceivers based on the obtained signal quality/strength.

According to a fourth aspect there is provided a digital interface, comprising one or more analog-to-digital converters, ADC's, one or more digital-to-analog converters, DAC's, a baseband, BB, processor and a serializer/deserializer, SerDes, the digital interface being connectable to one or more transceivers and connectable to an external processing unit and configured to: receive first configuration information from the external processing unit; configure a first set of the plurality of transceivers to be in a first operating mode for a first time period based on the first configuration information; configure a second set of the plurality of transceivers to be in a non-operating mode for the first time period based on the first configuration information; optionally receive second configuration information from the external processing unit; configure the second set of transceivers to be in a second operating mode for a second time period, the second time period following the first time period, optionally based on the second configuration information; receive a signal from each of the plurality of transceivers; transmit the received signals to the external processing unit; receive third configuration information from the external processing unit, the third configuration information being based on the received signals; and update the first and second sets of transceivers based on the third configuration information.

According to some embodiments, the one or more ADC's and/or the one or more DAC's is configured to operate with a first bit resolution in the first operating mode and with a second bit resolution in the second operating mode, the second bit resolution being lower than the first bit resolution and/or the received signals for the transceivers in the first set of transceivers are transmitted to the external processing unit with a first bit resolution and the received signals for the transceivers in the second set of transceivers are transmitted to the external processing unit with a second bit resolution, the second bit resolution being lower than the first bit resolution.

According to some embodiments, the digital interface further comprises a basic reference clock configured to generate a basic reference frequency, and a phase locked loop, PLL, configured to from the basic reference frequency generate a first or a second reference frequency, the second frequency being lower than the first frequency, and wherein the first reference frequency is utilized for the digital interface if the transceiver belongs to the first set of transceivers and wherein the second reference frequency is utilized for the digital interface if the transceiver belongs to the second set of transceivers.

According to some embodiments, the digital interface comprises a memory unit associated with the BB processor or the SerDes of the digital interface, the digital interface (400, . . . , 408) is configured to store, in the memory unit, the received signals for the transceivers in the second set of transceivers, and the digital interface is configured to transmit the stored signals to the external processing unit during a third time period, the third time period being shorter than the second time period.

According to some embodiments, the received signals for the transceivers in the first set of transceivers are transmitted to the external processor during the second time period.

According to some embodiments, the third time period is a portion of the second time period.

According to some embodiments, the portion of the second time period is a last portion of the second time period.

According to some embodiments, the third time period is a time period following the second time period.

According to some embodiments, the first reference frequency is utilized for clocking the digital interface while transmitting during the third time period Effects and features of the second, third, and fourth aspects are fully or to a large extent analogous to those described above in connection with the first aspect and vice versa.

Embodiments mentioned in relation to the first aspect are fully or largely compatible with the second, third, and fourth aspects and vice versa.

An advantage of some embodiments is that power consumption is reduced (for the system, for the transceivers, and/or for the digital interface).

Another advantage of some embodiments is that beam monitoring is more robust.

Yet another advantage of some embodiments is that processing by a processor/processing unit can be performed with fewer bits, thus increasing efficiency, provide faster processing and/or reduce power consumption.

Yet a further advantage of some embodiments is that by adapting the bit resolution for ADC/DAC, power consumption in the ADC/DAC is reduced, thus further reducing power consumption (overall/for the system/for the digital interface). A further advantage of some embodiments is that fewer bits need to be transferred via the digital interface, thus enabling simpler/less complex ADC/DAC and/or avoiding adaptation of ADC/DAC.

Yet another advantage of some embodiments is that more efficient processing is enabled.

Yet a further advantage of some embodiments is that power spikes may be reduced.

Yet another further advantage of some embodiments is that full channel knowledge is obtained and/or that no sweeping of antenna panels one at a time is needed, thus reducing time for measurements and/or improving beam tracking performance.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a flowchart illustrating method steps according to some embodiments;

FIG. 2 is a schematic drawing illustrating a computer readable medium according to some embodiments;

FIG. 3 is a flowchart illustrating method steps implemented in an apparatus according to some embodiments;

FIG. 4 is a schematic drawing illustrating a system comprising a processing unit and a digital interface according to some embodiments;

FIG. 5 is a schematic drawing illustrating a system comprising a processing unit and a plurality of digital interfaces according to some embodiments;

FIG. 6 is a schematic timing diagram illustrating modes for the plurality of transceivers according to some embodiments;

FIG. 7 is a flowchart illustrating method steps according to some embodiments; and

FIG. 8 is a flowchart illustrating method steps implemented in a digital interface according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a processor/processing unit. The processor may be a digital processor. Alternatively, the processor may be a microprocessor, a microcontroller, a central processing unit, a co-processor, a graphics processing unit, a digital signal processor, an image signal processor, a quantum processing unit, or an analog signal processor. The processing unit may comprise one or more processors and optionally other units, such as a control unit and/or a serializer/deserializer (SerDes).

Below is referred to “connection”, such as transceiver connection and serial connection. The connections are electrical connections and each of the units connected via a connection comprise input and/or output circuitry. In the case of a serial connection, one example of input and/or output circuitry is a SerDes.

Below is referred to first and second bit resolutions. If a unit has a first bit resolution, a first number of bits are utilized. If a unit has the second bit resolution, a second number of bits are utilized.

Below is referred to “power spike”. A power spike is a short pulse of high energy or high power.

Below is referred to “beam scanning”. Beam scanning may also be called beam tracking, beam sweeping or antenna selection. The use of mmW communication in handheld devices may be challenging since a user's hand holding the handheld device may block one or more antenna(s), and such blocking may for mmW cause a 10-30 dB signal loss. In order to combat this, one needs to distribute a number of antennas over the device and select a subset of the antennas not blocked in order to communicate satisfactory with the base station/network node. This process of selecting which antennas to use and combine for improved signal detection and transmission is called beam scanning or antenna selection.

### Embodiments

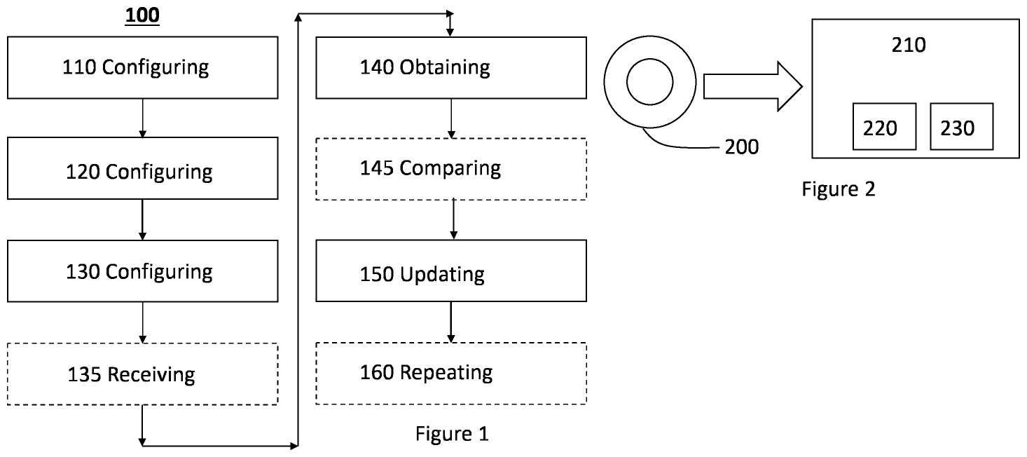

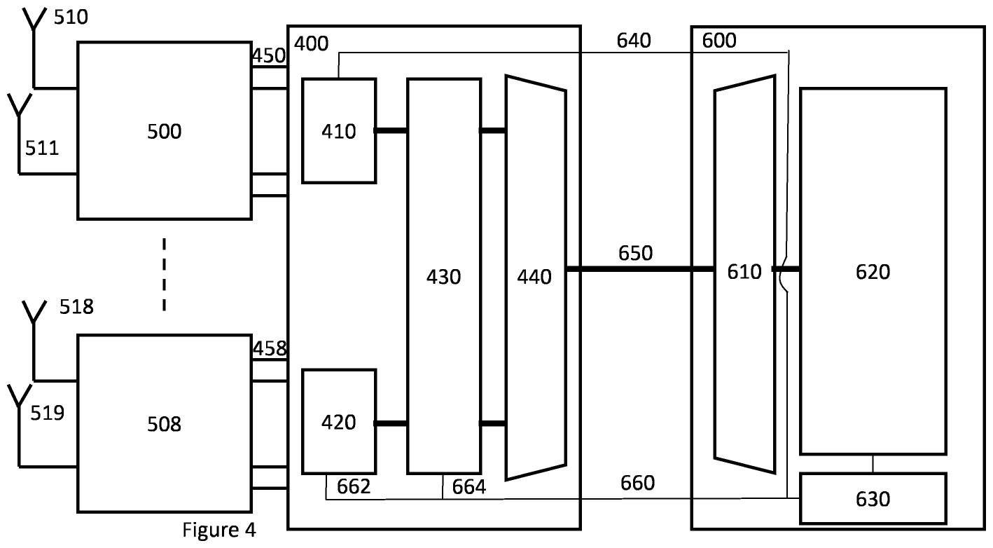

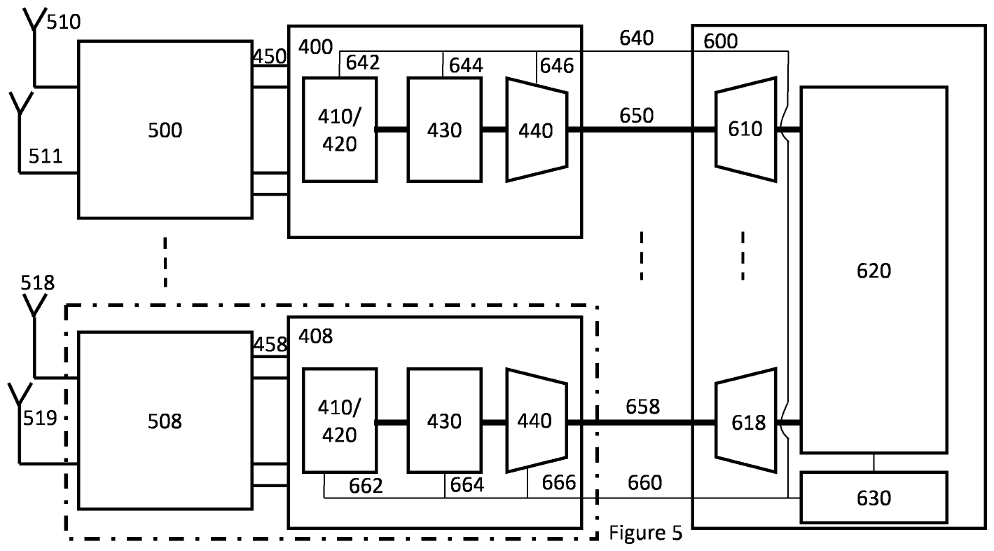

In the following, embodiments will be described where FIG. 1 illustrates method steps according to some embodiments. The method 100 is for (e.g., performed by) a processing unit 600 (shown in FIGS. 4 and 5). The processing unit 600 may be or comprise a (digital) baseband processor. Furthermore, the processing unit 600 is connectable or connected to a plurality of transceivers 500, . . . , 508 via one or more digital interfaces 400, . . . , 408 (shown in FIGS. 4 and 5). In some embodiments, the plurality of transceivers 500, . . . , 508 operate in a mmW frequency range, i.e., in a frequency range of or within 24-300 GHz. Furthermore, in some embodiments, the plurality of transceivers 500, . . . , 508 operate in a massive multiple-input multiple-output (Massive-MIMO) and/or a beamforming scenario. The method 100 comprises configuring 110 a first set of the plurality of transceivers 500, . . . , 508 to be in a first operating mode for a first time period. In some embodiments, the first time period is a time period during which no beam scanning or transceiver/antenna selection is performed. As an example, the first time period may be 15 ms long. Furthermore, the method 100 comprises configuring 120 a second set of the plurality of transceivers 500, . . . , 508 to be in a non-operating mode for the first time period. In some embodiments, the second set of the plurality of transceivers 500, . . . 508 comprises all transceivers that are not comprised in the first set of the plurality of transceivers 500, . . . , 508. Furthermore, in some embodiments the non-operating mode is a disabling mode or a stand-by mode, in which the transceivers consume no energy/power or less energy/power than in any of the first and second operating modes. Additionally, or alternatively, the non-operating mode is a mode, in which no transmission and/or reception of radio signals is performed. Moreover, the method 100 comprises configuring 130 the second set of transceivers to be in a second operating mode for a second time period. In some embodiments, the second time period is a time period during which beam scanning and/or transceiver/antenna selection is performed. As an example, the second time period may be 5 ms long. The second time period follows the first time period, e.g., the second time period is consecutive to (follows directly after) the first time period or the second time period follows the first time period with an extra time period between the first and second time periods. The method 100 comprises, during the second time period, obtaining 140 a signal quality (signal quality measurement) or a signal strength (signal strength measurement) for each of the plurality of transceivers 500, . . . , 508. The signal quality may comprise one or more of received quality (RQ), such as reference signals received quality (RSRQ), secondary synchronization signal reference signal received quality (SS-RSRQ), channel state information reference symbols reference signal received quality (CSI-RS RSRQ), signal to noise ratio (SNR), or signal to interference and noise ratio (SINR), such as secondary synchronization signal to interference and noise ratio (SS-SINR) or Layer 1 signal to interference and noise ratio (L1-SINR). The signal strength may comprise a received power (RP), such as reference signal received power (RSRP), secondary synchronization signal reference signal received power (SS-RSRP), channel state information reference symbols reference signal received power (CSI-RS RSRP) or Layer 1 reference signal received power (L1-RSRP), or a received signal strength indication, such as received signal strength indicator (RSSI). Preferably, the signal quality is an RSRQ. Preferably the signal strength is an RSRP. In some embodiments, the step of obtaining 140 comprises receiving (e.g., from one or more base stations) a (radio) signal or indication for (or from) each of the plurality of transceivers 500, . . . , 508, via one or more digital interface(s) 400, . . . , 408; and optionally estimating/calculating signal quality/strength for each of the plurality of transceivers from the received signals (if it is not directly indicated, e.g. by the indication, in the received signal). Furthermore, in some embodiments, the method 100 comprises comparing 145 signal strength/quality for the plurality of transceivers 500, . . . , 508 (after the step of obtaining 140). Moreover, the method 100 comprises, at the end of the second time period, updating 150 the first and second sets of transceivers based on the obtained signal quality/strength. Updating 150 may comprise moving one or more transceivers from the first set of transceivers to the second set of transceivers and/or moving one or more transceivers from the second set of transceivers to the first set of transceivers. Moreover, in some embodiments, updating 150 may comprise selecting the (e.g., 1, 2 or 4) transceiver(s) with the strongest power and/or highest quality for (to be in) the first set and selecting the rest of the plurality of transceivers 500, . . . , 508 for (to be in) the second set. In some embodiments, the updating 150 may be performed at the end, such as just before, exactly at or just after, e.g., 0.5 ms before, 0.5 ms after or up to 20 ms after the second time period, e.g., during a third time period. By allowing the updating to be performed after the second time period, the processor is enabled to give the updating process a lower priority compared to other jobs such as decoding and coding, and perform the update as a background process, thereby enabling more efficient processing.

In some embodiments, the method 100 comprises repeating 160 the steps 110, 120, 130, 140, 150 and optionally repeating the steps 135 and 145. The repeated steps may be repeated until a stop repeat criterion is met. A stop criterion may be that the steps have been repeated a user-definable number of times or that the processing unit 600 enters a stand-by mode or is turned off or that the system enters a stand-by mode or is turned off, e.g., by obtaining a connection release message, turning off the radio communication.

In some embodiments, for each of the transceivers in the first operating mode, i.e., in the first set, a first number of bits describing a signal, such as a signal received from a base station via an antenna associated with the transceiver, is transmitted to (or from) the processing unit 600 via an associated digital interface 400, . . . , 408. Thus, in these embodiments, the first operating mode is a mode, in which a first number of bits describing a signal is transmitted to (or from) the processing unit 600 via an associated digital interface 400, . . . , 408. In some embodiments, for each of the transceivers in the second operating mode (each of the transceivers in the second set), a second number of bits describing a signal, such as a signal received from a base station via an antenna associated with the transceiver, is transmitted to (or from) the processing unit 600 via an associated digital interface 400, . . . , 408. Thus, in these embodiments, the second operating mode is a mode, in which a second number of bits describing a signal is transmitted to (or from) the processing unit 600 via an associated digital interface 400, . . . , 408. The second number of bits is lower than the first number of bits. In some embodiments, for the transceivers in the non-operating mode, zero bits describing a signal are transmitted to (or from) the processing unit 600. Thus, in these embodiments, the non-operating mode is a mode, in which zero bits describing a signal are transmitted to (or from) the processing unit 600, i.e., a mode, in which no transmission and/or reception of radio signals is performed. Thus, bandwidth is saved and/or power consumption reduced. Besides bits describing a signal, there may also be control bits transmitted from (to) the processing unit 600 to (from) a digital interface 400, . . . , 408. Such control bits may be sent via separate control lines. Alternatively, the control bits may be sent via a serial connection between the processing unit 600 and a digital interface 400, . . . , 408 as explained below.

In some embodiments, the first number of bits is all available bits, i.e., N bits, N being e.g., 8, whereas the second number of bits is the N−x (N minus x) most significant bits (MSB), wherein x is e.g., 1, 2, 3, 4, 5, 6 or 7, such as the 1, 2, 3 or 4 MSB's. In some embodiments, the first number of bits is 4 or more and the second number of bits is 3 or less, wherein the 3 or less bits are the 3 or less MSB's of the signal. Furthermore, in some embodiments, the first number of bits is all available bits, e.g. N bits, whereas the second number of bits is the N-x least significant bits (LSB), N being e.g., 8 and x being e.g., 1, 2, 3, 4, 5, 6 or 7. In some embodiments, the method 100 comprises receiving 135 synchronization signals, such as one or more synchronization signal blocks (SSB's), i.e., one or more synchronization signal and PBCH blocks (SS/PBCH blocks), during the second time period. The receiving of synchronization signals may in some embodiments be done simultaneously for the plurality of transceiver, e.g., the same transmitted synchronization signal is received in each of the plurality of transceivers, and the signal quality/strength may be obtained for each of the plurality of transceivers based on the simultaneously received synchronization signal. By obtaining signal quality simultaneously for all of the plurality of transceivers, a better selection of transceivers of the first set of the plurality of transceivers 500, . . . , 508 may be obtained. In some embodiments, receiving 135 synchronization signals comprises receiving synchronization signals for each of the plurality of transceivers 500, . . . , 508 simultaneously. Furthermore, in some embodiments, obtaining 140 the signal quality/strength for each of the plurality of transceivers 500, . . . , 508 is in accordance with (based on) the simultaneously received synchronization signals for each of the plurality of transceivers 500, . . . , 508. Moreover, in some embodiments, obtaining 140 the signal quality/strength for each of the plurality of transceivers 500, . . . , 508 comprises obtaining the signal quality/strength for each of the plurality of transceivers 500, . . . , 508 from a corresponding synchronization signal, i.e., from a synchronization signal received by the same transceiver. In some embodiments, receiving 135 synchronization signals comprises receiving the same synchronization signal for each of the plurality of transceivers 500, . . . , 508. An SSB may comprise a first OFDM symbol (at least partly) utilized for the primary synchronization signal (PSS), a second OFDM symbol utilized for the physical broadcast channel (PBCH), a third OFDM symbol utilized for the secondary synchronization signal (SSS) and for the physical broadcast channel (PBCH) and a fourth OFDM symbol utilized for the physical broadcast channel (PBCH). The one or more SSB's may be comprised in an SSB burst, which may be up to 5 ms long. In some embodiments, the signal quality/strength is obtained from the received synchronization signals, e.g., from the SSB's. However, in other embodiments, beam management is carried out over other kinds of reference signals, such as temporary reference signals (TRS), tracking, reference signals (TRS), channel state information reference signals (CSI-RS), demodulation reference signals (DM-RS), and then the signal quality/strength may be obtained from or based on these signals. Furthermore, e.g., in the case of unlicensed operation, other kinds of synchronization signals, such as a discovery reference signal (DRS) may be received and then the signal quality/strength may be obtained from or based on these signals. In addition, any known signal (including downlink channel signals) or any signal, having a content, which can be deduced by the processing unit 600 (or a UE comprising the processing unit) may be utilized for synchronization, and thus the signal quality/strength may be obtained from or based on such signals.

In some embodiments, configuring 130 the second set of transceivers to be in a second operating mode for a second time period is only performed if the signal quality/strength for each of the transceivers of the first set of the plurality of transceivers fulfils a first criterion. A first criterion may be that the signal quality is measured as SNR or SINR and that the SNR/SINR of one or more transceivers of the first set has a value above a first threshold, such as −6, 0, or 6 decibels (dB). If the SNR/SINR of one or more (or all) transceivers of the first set has a value below the first threshold, a device, such as a UE, comprising the transceivers may be close to or approaching a location, which is out of coverage, and then full resolution of signal quality/strength for all transceivers (for both the first and the second sets) may improve the selection of transceivers for regular transmission, i.e., selection of the transceivers for the first set of transceivers. Thus, in this case the second set of transceivers are not set to be in a second operating mode for a second time period.

According to some embodiments, a computer program product comprising a non-transitory computer readable medium 200, such as a universal serial bus (USB) memory, a plug-in card, an embedded drive, a digital versatile disc (DVD), a read only memory (ROM) or a compact disc (CD) ROM, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer or a computing device 210 or the processing unit 600. When loaded into the data processing unit, the computer program may be stored in a memory (MEM) 230 associated with or comprised in the data-processing unit. According to some embodiments, the computer program may, when loaded into and run by the data processing unit, cause execution of method steps according to, for example, the method illustrated in FIG. 1, which is described herein.

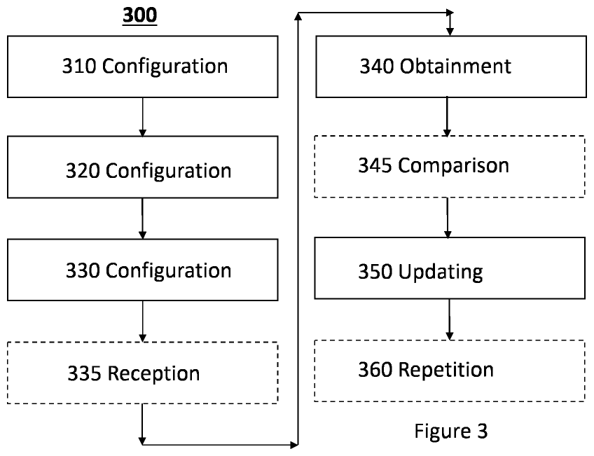

FIG. 3 illustrates method steps implemented in an apparatus 300 according to some embodiments. The apparatus 300 is connectable or connected to a plurality of transceivers 500, . . . , 508 via one or more digital interfaces 400, . . . , 408. Furthermore, the apparatus 300 comprises controlling circuitry. The controlling circuitry may be one or more processors, such as the processing unit 600 or a baseband processor. The controlling circuitry is configured to cause configuration 310 of a first set of the plurality of transceivers 500, . . . , 508 to be in a first operating mode for a first time period. To this end, the controlling circuitry may be associated with (e.g., operatively connectable, or connected, to) a first configuration unit (e.g., first configuration circuitry or a first configurator). Furthermore, the controlling circuitry is configured to cause configuration 320 of a second set of the plurality of transceivers 500, . . . , 508 to be in a non-operating mode for the first time period. To this end, the controlling circuitry may be associated with (e.g., operatively connectable, or connected, to) a second configuration unit (e.g., second configuration circuitry or a second configurator). In some embodiments, the second configuration unit is the same as the first configuration unit. Moreover, the controlling circuitry is configured to cause configuration 330 of the second set of transceivers to be in a second operating mode for a second time period, the second time period following the first time period. To this end, the controlling circuitry may be associated with (e.g., operatively connectable, or connected, to) a third configuration unit (e.g., third configuration circuitry or a third configurator). In some embodiments, the third configuration unit is the same as the first (and the second) configuration unit. Optionally, the controlling circuitry is configured to cause reception 335 of synchronization signals, such as one or more synchronization signal and PBCH blocks (SS/PBCH blocks), during the second time period. To this end, the controlling circuitry may be associated with (e.g., operatively connectable, or connected, to) a reception unit (e.g., receiving circuitry or a receiver). The controlling circuitry is configured to cause, during the second time period, obtainment 340 of a signal quality/strength for each of the plurality of transceivers 500, . . . , 508. To this end, the controlling circuitry may be associated with (e.g., operatively connectable, or connected, to) an obtainment unit (e.g., obtainment circuitry or an obtainer). Optionally, the controlling circuitry is configured to cause comparison 345 of signal strength/quality for the plurality of transceivers 500, . . . , 508, e.g., after the obtainment 340. To this end, the controlling circuitry may be associated with (e.g., operatively connectable, or connected, to) a comparing unit (e.g., comparing circuitry or a comparator). Furthermore, the controlling circuitry is configured to cause, at the end of the second time period, updating 350 of the first and second sets of transceivers based on the obtained signal quality/strength. To this end, the controlling circuitry may be associated with (e.g., operatively connectable, or connected, to) an updating unit (e.g., updating circuitry or an updater). Optionally, the controlling circuitry is configured to cause repetition 360 of the configurations 310, 320, 330, the obtainment 340, the updating 350 and optionally the reception 335 and the comparison 345. To this end, the controlling circuitry may be associated with (e.g., operatively connectable, or connected, to) a repetition unit (e.g., repetition circuitry or a repeater).

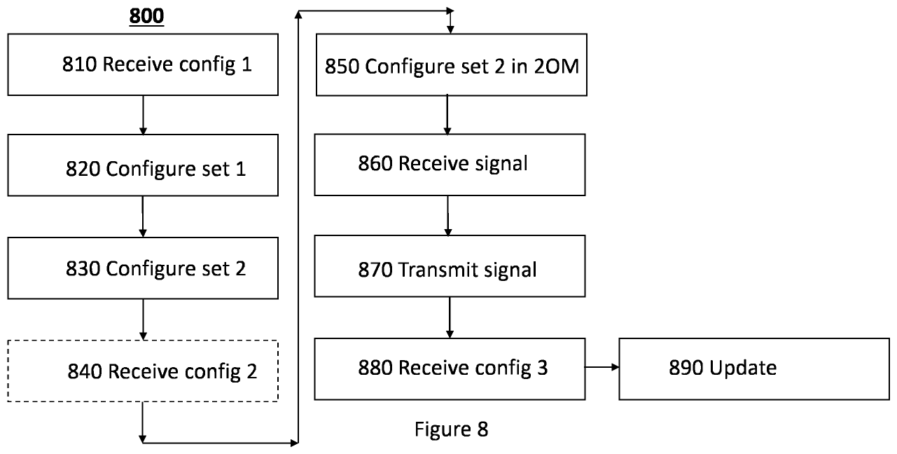

FIG. 4 illustrates an external processing unit 600 and a digital interface 400 according to some embodiments. The external processing unit 600 is connectable or connected to the digital interface 400. Furthermore, the digital interface 400 is connectable or connected to a plurality of transceivers 500, . . . , 508, e.g., via transceiver connections 450, . . . , 458. Moreover, the transceivers 500, . . . , 508 are each connectable or connected to one or more respective antennas 510, 511, . . . , 518, 519, e.g., via an antenna port. However, in some embodiments, the antennas 510, 511, . . . , 518, 519 are integrated with an associated transceiver 500, . . . , 508, e.g., in the same encapsulation. In some embodiments, a system, such as a UE, comprises the external processing unit 600, the digital interface 400, the plurality of transceivers 500, . . . , 508 and the one or more antennas 510, 511, . . . , 518, 519. The digital interface 400 comprises one or more analog-to-digital converters (ADC's) 410, one or more digital-to-analog converters (DAC's) 420, a baseband (BB) processor 430 and a serializer/deserializer (SerDes) 440. In some embodiments, each ADC 410 and DAC 420 is associated with only one antenna 510, 511, . . . , 518, 519. The external processing unit 600 comprises a SerDes 610, a digital baseband processor 620 and optionally a control unit 630, such as a digital interface controller/chip. The digital interface 400 is connectable or connected to the external processing unit 600, e.g., via a serial connection 650 between the SerDes 440 of the digital interface 400 and the SerDes 610 of the external processing unit 600. Optionally, the digital interface 400 is connectable or connected to the external processing unit 600 via control lines 640, 660, 662, 664 for controlling and/or sending configuration information to the one or more ADC's 410, the one or more DAC's 420 and the BB processor 430. Additionally, or alternatively, control bits and/or configuration information may be sent from the external processing unit 600 to the digital interface 400 (and hence to the one or more ADC's 410, the one or more DAC's 420 and the BB processor 430 thereof) via the serial connection 650. In some embodiments, as illustrated in FIG. 8, method steps of a method 800 are implemented in the digital interface 400. In these embodiments, the digital interface 400 is configured to receive 810 first configuration information from the external processing unit 600. In some embodiments, the first configuration information comprises information about which transceivers of the plurality of transceivers 500, . . . , 508 belong to a first set of the plurality of transceivers 500, . . . , 508 and optionally information about which transceivers belong to the second set of the plurality of transceivers 500, . . . , 508. In some embodiments, all transceivers not belonging to the first set belongs to the second set. In these embodiments, no information about which transceivers belong to the second set of the plurality of transceivers 500, . . . , 508 is sent or received. Alternatively, the first configuration information comprises only information about which transceivers of the plurality of transceivers 500, . . . , 508 belong to the second set of the plurality of transceivers 500, . . . , 508, i.e., no information about which transceivers belong to the first set of the plurality of transceivers 500, . . . , 508 is sent or received. Thus, bandwidth is saved, leading to a reduced power consumption. Alternatively, the first configuration information comprises for each transceiver 500, . . . , 508 information about which mode the respective transceiver 500, . . . , 508 is to be in. Furthermore, the digital interface 400 is configured to configure 820 a first set of the plurality of transceivers 500, . . . , 508 to be in a first operating mode for a first time period based on the first configuration information. Moreover, the digital interface 400 is configured to configure 830 a second set of the plurality of transceivers 500, . . . , 508 to be in a non-operating mode for the first time period based on the first configuration information. The digital interface 400 is optionally configured to receive 840 second configuration information from the external processing unit 600. The second configuration information is indicative of a time, at (such as precisely at) which the second set of transceivers are to be set in a second operating mode. However, in some embodiments, the digital interface 400 comprises a synchronization unit (not shown) keeping count on when different actions, such as setting the second set of transceivers to a second operating mode, is to be performed. In these embodiments, second configuration information is not sent/received. Furthermore, the digital interface 400 is configured to configure 850 the second set of transceivers to be in a second operating mode for a second time period, the second time period following the first time period. In some embodiments, configuration of the second set of transceivers to be in a second operating mode for a second time period is based on the second configuration information. Moreover, the digital interface 400 is configured to receive 860, e.g., during the second time period, a (radio) signal or an indication for or from each of the plurality of transceivers 500, . . . , 508. The signal/indication may be sent from one or more base stations. The indication may be indicative of a signal quality/strength. The digital interface 400 is configured to transmit 870, e.g., during the second time period, the received signals/indications to the external processing unit 600. Thus, the signals/indications are received, analog to digital converted by the ADC's, optionally processed by the BB processor 430, serialized by the SerDes and sent (digitally and serially) via the serial connection 650 to the external processing unit 600. Furthermore, the digital interface 400 is configured to receive 880, e.g., during the second time period, third configuration information from the external processing unit 600, the third configuration information being based on the received signals. As an example, the external processing unit 600 may from the received signals/indications estimate or calculate signal quality/strength for each of the plurality of transceivers (e.g., if it is not directly indicated, e.g., by the indication, in the received signal), compare signal strength/quality for the plurality of transceivers 500, . . . , 508, select the (e.g. 1, 2 or 4) transceiver(s) with the strongest power and/or highest quality for the first set and select the rest of the plurality of transceivers 500, . . . , 508 for the second set, and in the third configuration information indicate which transceivers are to be in the first set of transceivers and optionally indicate which transceivers are to be in the second set of transceivers. Alternatively, the third configuration information comprises for each transceiver 500, . . . , 508 information about which mode the respective transceiver 500, . . . , 508 is to be in. The first, second and/or third configuration information is sent to the digital interface 400 via the control lines 640, 660, 662, 664 or via the serial connection 650. Moreover, the digital interface 400 is configured to update 890 (e.g., at the end of the second time period) the first and second sets of transceivers based on the third configuration information. Optionally, the digital interface 400 is configured to repeat some or all of the above-mentioned actions. As an example, if repeated, for the second and subsequent loops, information about the updated first and second sets of transceivers may be utilized instead of sending and utilizing the first configuration information.

FIG. 5 illustrates a processing unit 600 and a plurality of digital interfaces 400, . . . , 408 according to some embodiments. The external processing unit 600 is connectable or connected to the digital interfaces 400, . . . , 408. Furthermore, each of the digital interfaces 400, . . . , 408 are connectable or connected to a plurality of transceivers 500, . . . , 508, e.g., via transceiver connections 450, . . . , 458. Preferably, each of the digital interfaces 400, . . . , 408 are connectable or connected to a one transceiver 500, . . . , 508. Moreover, the transceivers 500, . . . , 508 are each connectable or connected to one or more respective antennas 510, 511, . . . , 518, 519, e.g., via an antenna port. In some embodiments, a system, such as a UE, comprises the external processing unit 600, the digital interfaces 400, . . . , 408, the plurality of transceivers 500, . . . , 508 and the one or more antennas 510, 511, . . . , 518, 519. In some embodiments, each, or some of the digital interfaces 400, . . . , 408 are encapsulated and/or integrated (on one single chip) with an associated transceiver 500, . . . , 508 and optionally with the antennas 510, 511, . . . , 518, 519 associated with the associated transceiver 500, . . . , 508. Each of the digital interfaces 400, . . . , 408 comprises one or more ADC's 410, such as one ADC for each antenna of the associated transceiver 500, . . . , 508, one or more digital-to-analog converters (DAC's) 420, such as one DAC for each antenna of the associated transceiver 500, . . . , 508, a BB processor 430 and a SerDes 440. Thus, in some embodiments, each ADC 410 and DAC 420 is associated with only one antenna 510, 511, . . . , 518, 519. The external processing unit 600 comprises a SerDes 610, . . . , 618 for each of the digital interfaces 400, . . . , 408, a digital baseband processor 620 and optionally a control unit 630, such as a digital interface controller/chip. Each digital interface 400, . . . , 408 is connectable or connected to the external processing unit 600, e.g., via a serial connection 650, . . . , 658 between the SerDes 440 of the digital interface 400, . . . , 408 and the SerDes 610, . . . , 618 of the external processing unit 600 associated with the respective digital interface 400, . . . , 408. Optionally, each digital interface 400, . . . , 408 is connectable or connected to the external processing unit 600 via control lines 640, 642, 644, 646, . . . , 660, 662, 664, 666 for controlling and/or sending configuration information to the one or more ADC's 410, the one or more DAC's 420 and the BB processor 430 of each digital interface 400, . . . , 408. Additionally, or alternatively, control bits and/or configuration information may be sent from the external processing unit 600 to each of the digital interfaces 400, . . . , 408 via the serial connections 650, . . . , 658. The digital interfaces 400, . . . , 408 are configured to perform the same or similar actions as described above in connection with FIG. 4.

In some embodiments, the one or more ADC's 410 and/or the one or more DAC's 420 are configured to operate with a first bit resolution in the first operating mode and with a second bit resolution in the second operating mode. Thus, in these embodiments, the first operating mode is a mode in which the one or more ADC's 410 and/or the one or more DAC's 420 are configured to operate with a first bit resolution. Furthermore, in these embodiments, the second operating mode is a mode in which the one or more ADC's 410 and/or the one or more DAC's 420 are configured to operate with a second bit resolution. The second bit resolution is lower than the first bit resolution. In some embodiments, the first bit resolution corresponds to all available bits N, e.g., 8, and the second bit resolution corresponds to the N−x MSB's, wherein x is e.g., 1, 2, 3, 4, 5, 6 or 7. Thus, bandwidth is saved and/or power consumption/spikes reduced. In some embodiments, the first and/or second bit resolution is higher than zero. The one or more ADC's 410 and/or the one or more DAC's 420 may be configured to operate with the first or second bit resolution by the processing unit 600 sending control bits via control lines 640, 642, 660, 662, by the processing unit 600 sending control bits via a serial connection 650, . . . , 658 or by the BB processor 430 of the same digital interface 400, . . . , 408 controlling the ADC 410 and/or the DAC 420. Additionally, or alternatively, the received signals for the transceivers in the first set of transceivers are transmitted to the external processing unit 600 with a first bit resolution and the received signals for the transceivers in the second set of transceivers are transmitted to the external processing unit 600 with a second bit resolution. The second bit resolution is lower than the first bit resolution. Thus, bandwidth is saved and/or power consumption/spikes reduced. As an example, the internal BB processor 430 receives information/bits (about the received signals) from the one or more ADC's 410 and for the information from the transceivers in the second set the internal BB processor 430 truncates or shortens the information (received from the ADC 410) by removing one or more LSB and then relays/forwards the rest of the information, i.e., the one or more MSB's, to the SerDes 440. The information (received from the ADC 410) from the transceivers in the first set is only relayed/forwarded (without processing by the internal BB processor 430) to the SerDes 440. In some embodiments, the internal BB processor 430 truncates or shortens the information based on control bits received from the processing unit 600 via control lines 640, 644, 660, 664 or via a serial connection 650, . . . , 658 or based on information stored in a memory associated with the BB processor 430.

Returning to FIG. 4, in some embodiments, the digital interface 400 further comprises a basic reference clock configured to generate a basic reference frequency. Furthermore, the digital interface 400 comprises a phase locked loop, PLL. The PLL is configured to from the basic reference frequency either generate a first and/or a second reference frequency (e.g., depending on control signals; associated with a sample time instance). The second frequency is lower than the first frequency. Furthermore, the first reference frequency is utilized for (e.g., to clock) the digital interface 400 if a transceiver associated with (e.g., connected to) the digital interface 400 belongs to the first set of transceivers. Moreover, the second reference frequency is utilized for (e.g., to clock) the digital interface 400 if the transceiver associated with (e.g., connected to) the digital interface 400 belongs to the second set of transceivers. Thus, a lower frequency is utilized for clocking the digital interface 400 if the transceiver belongs to the second set of transceivers. Hence, power consumption and/or power spikes may be reduced.

Returning to FIG. 5, in some embodiments, the digital interface 400, . . . , 408 comprises a memory unit associated with (e.g., connectable or connected to) the BB processor 430 or the SerDes 440 of the digital interface 400, . . . , 408. Furthermore, the digital interface 400, . . . , 408 comprises a basic reference clock configured to generate a basic reference frequency and a phase locked loop, PLL, configured to from the basic reference frequency generate a third reference frequency (associated with a sample time instance). In these embodiments, the received signals for the transceivers in the first set of transceivers may be transmitted to the external processor 600 during the second time period, e.g., directly transmitted to the external processor 600 during the second time period. However, the digital interface 400, . . . , 408 is configured to store, in the memory unit, the received signals for the transceivers in the second set of transceivers (e.g., during the second time period). Furthermore, the digital interface 400, . . . , 408 is configured to transmit the stored signals to the external processing unit 600 during a third time period. The third time period is shorter than the second time period. The third time period may be a portion (e.g., the last part/portion) of the second time period or a time period following (e.g., consecutive to) the second time period. Moreover, the first reference frequency is utilized for (e.g., to clock) the digital interface 400 while transmitting during the third time period. By transmitting the received signals for the transceivers in the first set of transceivers during the second time period while transmitting the received signals for the transceivers in the second set of transceivers during a time period following the second time period, power spikes may be reduced.

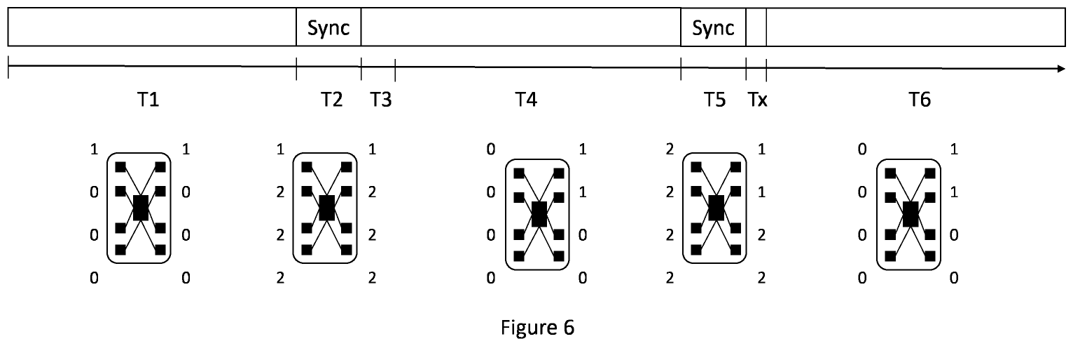

FIG. 6 is a schematic timing diagram illustrating modes for the plurality of transceivers over time according to some embodiments. For a first time period T1, a first set of the plurality of transceivers 500, . . . , 508 have been configured to be in a first operating mode 1. Furthermore, a second set of the plurality of transceivers 500, . . . , 508 have been configured to be in a non-operating mode 0 for the first time period T1. Moreover, the second set of transceivers are configured to be in a second operating mode 2 for a second time period T2. The second time period T2 follows the first time period T1. In some embodiments, the second time period T2 is consecutive to the first time period T1. Furthermore, in some embodiments, the second time period is a synchronization time period. Moreover, in some embodiments, (as seen in FIG. 6), the transceivers in the first set do not change mode from the first time period T1 to the second time period T2. The second time period T2 is utilized for obtaining a signal quality/strength for each of the plurality of transceivers 500, . . . , 508. Furthermore, at or about the end of the second time period, the first and second sets of transceivers are updated based on the obtained signal quality/strength. In some embodiments, the digital interface 400, . . . , 408 comprises a memory unit associated with the BB processor 430 or the SerDes 440 of the digital interface 400, . . . , 408, and is configured to store, in the memory unit, received signals for the transceivers of the second set, and is configured to transmit the stored signals to the external processing unit 600 during a third time period T3. The third time period T3 is shorter than the second time period T2. The third time period T3 may be a portion (e.g., the last part) of the second time period T2 or a time period following (e.g., consecutive to) the second time period T3 (as seen in FIG. 6). In these embodiments, the first and second sets of transceivers are updated at or about the end of the third time period T3, based on the obtained signal quality/strength. As seen in FIG. 6, the first and second sets have been updated for a fourth time period T4, e.g., for a second instance of the first time period T1. Furthermore, the second set has again been configured to be in a non-operating mode 0 (during the fourth time period T4). The fourth time period T4 follows the second time period T2 (and the third time period). In some embodiments, the fourth time period T4 is consecutive to the second time period T2. In some embodiments, the fourth time period T4 is consecutive to the third time period T3. Furthermore, the second set is configured to be in a second operating mode 2 for a fifth time period T5, e.g., for a second instance of the second time period T2. As seen in FIG. 6, an instance of the second time period T2, i.e., the fifth time period T5, does not have to be directly followed by an instance of the first time period T1, i.e., the sixth time period T6. Instead, there may be an extra time period Tx between an instance of the second time period T2, i.e., the fifth time period T5, and an instance of the first time period T1, i.e., the sixth time period T6, and vice versa. Moreover, as seen in FIG. 6, the first and second sets are the same during the fifth and the sixth time periods T5, T6. Thus, no updating was needed between the fifth and the sixth time periods T5, T6. In some embodiments, if no updating is needed, a special control signal or no control signal is sent from the processing unit 600 to the digital interface 400, . . . , 408 via control lines 640, 660 or via serial connection 650, . . . , 658, thus reducing control signalling and hence further reducing power consumption and/or power spikes.

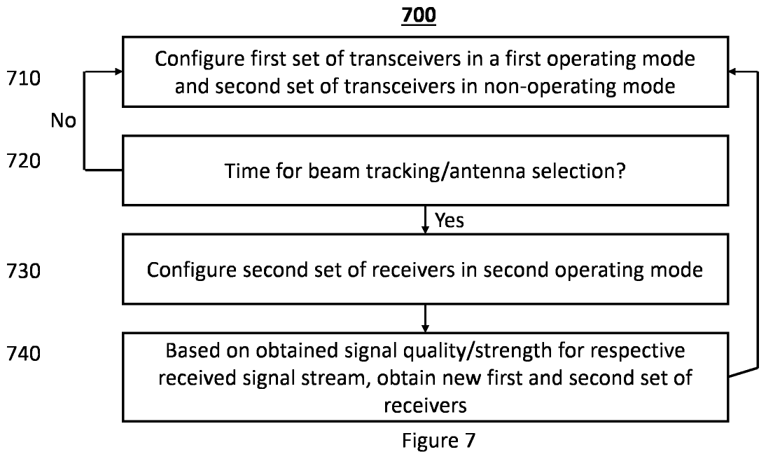

FIG. 7 is a flowchart illustrating method steps of a method 700 according to some embodiments. The method is performed by the processing unit 600 or by a digital interface 400, . . . , 408. The method 700 comprises configuring 710 a first set of transceivers of the plurality of transceivers 500, . . . , 508 to be in a first operating mode 1 (e.g., for a first time period). Furthermore, the method 700 comprises configuring a second set of receivers of the plurality of transceivers 500, . . . , 508 to be in a non-operating mode 0 (e.g., for a first time period). Moreover, the method 700 comprises monitoring 720 if it is time for beam scanning and/or antenna selection. In some embodiments, it is time for beam tracking and/or antenna selection when a predetermined time period has elapsed. In some embodiments, it is time for beam tracking and/or antenna selection when a synchronization signal is received. Thus, in some embodiments, if it is not yet time for beam tracking and/or antenna selection, the monitoring is continued but no other action is performed. The method 700 comprises, if/when it is time for beam tracking and/or antenna selection, configuring 730 the second set to be in a second operating mode 2 (e.g., for a second time period, such as a synchronization time period). Furthermore, the method 700 comprises obtaining signal quality/strength for each of the plurality of transceivers 500, . . . , 508 and based on the obtained signal quality/strength for each of the plurality of transceivers 500, . . . , 508, obtaining 730 new first and second sets (or updating the first and second sets. The method 700 may also comprise, after obtaining 730, returning to configuring 710, e.g., repeating the method. In some embodiments, the method 700 is part of the method 100 described above in connection with FIG. 1.

### List of Examples

1. A method (100) for a processing unit (600), the processing unit (600) being connectable to a plurality of transceivers (500, . . . , 508) via one or more digital interfaces (400, . . . , 408), comprising:
   a. configuring (110) a first set of the plurality of transceivers (500, . . . , 508) to be in a first operating mode for a first time period;
   b. configuring (120) a second set of the plurality of transceivers (500, . . . , 508) to be in a non-operating mode for the first time period;
   c. configuring (130) the second set of transceivers to be in a second operating mode for a second time period, the second time period following the first time period;
   d. during the second time period obtaining (140) a signal quality/strength for each of the plurality of transceivers (500, . . . , 508); and
   e. at the end of the second time period, updating (150) the first and second sets of transceivers based on the obtained signal quality/strength.
2. The method of example 1, further comprising:
   f. repeating (160) steps a-e.
3. The method of any of examples 1-2, wherein for each of the transceivers in the first operating mode, a first number of bits describing a signal is transmitted to/from the processing unit (600) via an associated digital interface (400, . . . , 408), wherein for each of the transceivers in the second operating mode, a second number of bits describing a signal, the second number of bits being lower than the first number of bits, is transmitted to the processing unit (600) via an associated digital interface (400, . . . , 408) and for the transceivers in the non-operating mode, zero bits describing a signal are transmitted to the processing unit.
4. The method of any of examples 1-3, further comprising:
   receiving (135) synchronization signals, such as one or more synchronization signal block, SSB, during the second time period.
5. The method of any of examples 1-4, wherein configuring (130) the second set of transceivers to be in a second operating mode for a second time period is only performed if the signal quality/strength for each of the transceivers of the first set of the plurality of transceivers fulfils a first criterion.
6. A computer program product comprising a non-transitory computer readable medium (200), having stored thereon a computer program comprising program instructions, the computer program being loadable into a data processing unit (220) and configured to cause execution of the method of any of examples 1-5 when the computer program is run by the data processing unit.
7. An apparatus (300), connectable to a plurality of transceivers (500, . . . , 508) via one or more digital interfaces (400, . . . , 408), comprising control circuitry, the control circuitry being configured to cause:
   a. configuration (310) of a first set of the plurality of transceivers (500, . . . , 508) to be in a first operating mode for a first time period;
   b. configuration (320) of a second set of the plurality of transceivers (500, . . . , 508) to be in a non-operating mode for the first time period;
   c. configuration (330) of the second set of transceivers to be in a second operating mode for a second time period, the second time period following the first time period;
   d. during the second time period, obtainment (340) of a signal quality/strength for each of the plurality of transceivers (500, . . . , 508); and
   e. at the end of the second time period, updating (350) of the first and second sets of transceivers based on the obtained signal quality/strength.
8. A digital interface (400), comprising one or more analog-to-digital converters, ADC's (410), one or more digital-to-analog converters, DAC's (420), a baseband, BB, processor (430) and a serializer/deserializer, SERDES (440), the digital interface (400) being connectable to one or more transceivers (500, . . . , 508) and connectable to an external processing unit (600) and configured to:
   a. receive first configuration information from the external processing unit (600);
   b. configure a first set of the plurality of transceivers (500, . . . , 508) to be in a first operating mode for a first time period based on the first configuration information;
   c. configure a second set of the plurality of transceivers (500, . . . , 508) to be in a non-operating mode for the first time period based on the first configuration information;
   d. optionally receive second configuration information from the external processing unit (600);
   e. configure the second set of transceivers to be in a second operating mode for a second time period, the second time period following the first time period, optionally based on the second configuration information;
   f. receive a signal from each of the plurality of transceivers (500, . . . , 508);
   g. transmit the received signals to the external processing unit (600);
   h. receive third configuration information from the external processing unit (600), the third configuration information being based on the received signals; and
   i. update the first and second sets of transceivers based on the fourth configuration information.
9. The digital interface of example 8, wherein the one or more ADC's (410) and/or the one or more DAC's (420) is configured to operate with a first bit resolution in the first operating mode and with a second bit resolution in the second operating mode, the second bit resolution being lower than the first bit resolution, and/or wherein the received signals for the transceivers in the first set of transceivers are transmitted to the external processing unit (600) with a first bit resolution and the received signals for the transceivers in the second set of transceivers are transmitted to the external processing unit (600) with a second bit resolution, the second bit resolution being lower than the first bit resolution.
10. The digital interface of any of examples 8-9, further comprising a basic reference clock configured to generate a basic reference frequency, and a phase locked loop, PLL, configured to from the basic reference frequency generate a first or a second reference frequency, the second frequency being lower than the first frequency, and wherein the first reference frequency is utilized for the digital interface (400) if the transceiver belongs to the first set of transceivers and wherein the second reference frequency is utilized for the digital interface (400) if the transceiver belongs to the second set of transceivers.
11. The digital interface of any of examples 8-9, wherein the digital interface (400, . . . , 408) comprises a memory unit associated with the BB processor (430) or the SERDES (440) of the digital interface (400, . . . , 408), wherein the digital interface (400, . . . , 408) is configured to store, in the memory unit, the received signals for the transceivers in the second set of transceivers, and wherein the digital interface (400, . . . , 408) is configured to transmit the stored signals to the external processing unit (600) during a third time period, the third time period being shorter than the second time period.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method for a processing unit, the processing unit (600) being connectable to a plurality of transceivers via one or more digital interfaces, comprising:
configuring a first set of the plurality of transceivers to be in a first operating mode for a first time period;
configuring a second set of the plurality of transceivers to be in a non-operating mode for the first time period;
configuring the second set of transceivers to be in a second operating mode for a second time period, the second time period following the first time period;
during the second time period obtaining a signal quality/strength for each of the plurality of transceivers; and
at the end of the second time period, updating the first and second sets of transceivers based on the obtained signal quality/strength.

2. The method of claim 1, further comprising:
repeating the steps of configuring a first set of the plurality of transceivers to be in a first operating mode for a first time period; configuring a second set of the plurality of transceivers to be in a non-operating mode for the first time period; configuring the second set of transceivers to be in a second operating mode for a second time period, the second time period following the first time period; during the second time period obtaining a signal quality/strength for each of the plurality of transceivers; and
at the end of the second time period, updating the first and second sets of transceivers based on the obtained signal quality/strength.

3. The method of claim 1, wherein for each of the transceivers in the first operating mode, a first number of bits describing a signal is transmitted to/from the processing unit via an associated digital interface, wherein for each of the transceivers in the second operating mode, a second number of bits describing a signal, the second number of bits being lower than the first number of bits, is transmitted to/from the processing unit via an associated digital interface and for the transceivers in the non-operating mode, zero bits describing a signal are transmitted to/from the processing unit.

4. The method of claim 1, further comprising: receiving one or more synchronization signals during the second time period.

5. The method of claim 4, wherein receiving synchronization signals comprises receiving synchronization signals for each of the plurality of transceivers simultaneously.

6. The method of claim 5, wherein obtaining the signal quality/strength for each of the plurality of transceivers is in accordance with the simultaneously received synchronization signals.

7. The method of claim 5, wherein obtaining the signal quality/strength for each of the plurality of transceivers comprises obtaining the signal quality/strength for each of the plurality of transceivers from a corresponding synchronization signal.

8. The method of claim 5, wherein receiving synchronization signals comprises receiving the same synchronization signal for each of the plurality of transceivers.

9. The method of claim 4, wherein the one or more synchronization signals are one or more synchronization signal blocks, SSBs.

10. The method of claim 1, wherein configuring the second set of transceivers to be in a second operating mode for a second time period is only performed if the signal quality/strength for each of the transceivers of the first set of the plurality of transceivers fulfils a first criterion, wherein the signal quality is measured as a signal to noise ratio (SNR) and the first criterion is fulfilled if the SNR of one or more transceivers of the first set has a value above a first threshold or wherein the signal quality is measured as a signal to interference and noise ratio (SINR) and the first criterion is fulfilled if the SINR of one or more transceivers of the first set has a value above a first threshold.

11-13. (canceled)

14. An apparatus, connectable to a plurality of transceivers via one or more digital interfaces, comprising control circuitry, the control circuitry being configured to cause:
configuration of a first set of the plurality of transceivers to be in a first operating mode for a first time period;
configuration of a second set of the plurality of transceivers to be in a non-operating mode for the first time period;
configuration of the second set of transceivers to be in a second operating mode for a second time period, the second time period following the first time period;
during the second time period, obtainment of a signal quality/strength for each of the plurality of transceivers; and
at the end of the second time period, updating of the first and second sets of transceivers based on the obtained signal quality/strength.

15. A digital interface, comprising one or more analog-to-digital converters, ADC's, one or more digital-to-analog converters DAC's, a baseband BB processor and a serializer/deserializer SERDES, the digital interface being connectable to one or more transceivers and connectable to an external processing unit and configured to:
receive first configuration information from the external processing unit;
configure a first set of the plurality of transceivers to be in a first operating mode for a first time period based on the first configuration information;
configure a second set of the plurality of transceivers to be in a non-operating mode for the first time period based on the first configuration information;
configure the second set of transceivers to be in a second operating mode for a second time period, the second time period following the first time period;
receive a signal from each of the plurality of transceivers;
transmit the received signals to the external processing unit;
receive third configuration information from the external processing unit, the third configuration information being based on the received signals; and
update the first and second sets of transceivers based on the third configuration information.

16. The digital interface of claim 15, further configured to receive second configuration information from the external processing unit and wherein configuring the second set of transceivers to be in a second operating mode for a second time period is based on the second configuration information.

17. The digital interface of claim 15, wherein the one or more ADC's and/or the one or more DAC's is configured to operate with a first bit resolution in the first operating mode and with a second bit resolution in the second operating mode, the second bit resolution being lower than the first bit resolution.

18. The digital interface of claim 15, wherein the received signals for the transceivers in the first set of transceivers are transmitted to the external processing unit with a first bit resolution and the received signals for the transceivers in the second set of transceivers are transmitted to the external processing unit with a second bit resolution, the second bit resolution being lower than the first bit resolution.

19. The digital interface of claim 15, further comprising a basic reference clock configured to generate a basic reference frequency, and a phase locked loop PLL configured to from the basic reference frequency generate a first or a second reference frequency, the second frequency being lower than the first frequency, and wherein the first reference frequency is utilized for the digital interface if the transceiver belongs to the first set of transceivers and wherein the second reference frequency is utilized for the digital interface if the transceiver belongs to the second set of transceivers.

20. The digital interface of claim 15, wherein the digital interface comprises a memory unit associated with the BB processor or the SERDES of the digital interface, wherein the digital interface is configured to store, in the memory unit, the received signals for the transceivers in the second set of transceivers, and wherein the digital interface is configured to transmit the stored signals to the external processing unit during a third time period, the third time period being shorter than the second time period.

21. The digital interface of claim 20, wherein the received signals for the transceivers in the first set of transceivers are transmitted to the external processor during the second time period.

22. The digital interface of claim 20, wherein the third time period is a portion of the second time period.

23. The digital interface of claim 22, wherein the portion of the second time period is a last portion of the second time period or a time period following the second time period.

24-25. (canceled)
